(19) United States
(12) Patent Application Publication
(10) Pub. No.: US 2024/0248372 A1
(43) Pub. Date: Jul. 25, 2024

(54) CAMERA DEVICE

(71) Applicant: LG INNOTEK CO., LTD., Seoul (KR)

(72) Inventors: Sun Min HWANG, Seoul (KR); Min Woo LEE, Seoul (KR)

(21) Appl. No.: 18/564,392

(22) PCT Filed: May 28, 2022
(86) PCT No.: PCT/KR2022/007619

§ 371 Date: Nov. 27, 2023

(30) Foreign Application Priority Data
May 28, 2021 (KR) 10-2021-0069563

(51) Int. Cl. G03B 5/04

(52) U.S. Cl. CPC G03B 5/04

(57) ABSTRACT

A camera device comprises: a moving portion including a lens; a fixed portion coupled to the moving portion; a plate arranged between the moving portion and the fixed portion; and an adjuster which adjusts the movement of the moving portion. The adjuster comprises an elastic member, an adjusting member, and a body. The body comprises a base, a first sidewall extending from the base and coming into contact with the fixed portion, and a second sidewall extending from the base and coming into contact with the moving portion.

### TECHNICAL FIELD

The present embodiment relates to a camera device.

### BACKGROUND ART

Recently, a subminiature camera module has been developed, and the miniature camera module is widely used in small electronic products such as smart phones, laptop computers, and game consoles.

As the spread of automobiles has become popular, subminiature cameras are widely used not only in small electronic products but also in vehicles. For example, black box cameras for vehicle protection or objective data on traffic accidents, rear surveillance cameras enabling the driver to monitor blind spots at the rear of the vehicle through a screen to ensure safety when reversing the vehicle, ambient detection cameras capable of monitoring the surroundings of the vehicle, and the like are provided.

Meanwhile, with the advancement of technology, there is a trend of applying a lane keeping assist system (LKAS), which receives video signals from the road ahead and analyzes them in real time and detects lane departure situations caused by the driver's carelessness or drowsy driving to generate an alarm by receiving the signals.

However, due to differences in vehicle size and wind glass angle for each vehicle, a separate coupler, and the like must be used for each vehicle to optimize the angle of view for the camera for the lane keeping assist system, and accordingly, there is a problem that the cost of the mold is incurring.

### DETAILED DESCRIPTION OF THE INVENTION

### Technical Subject

The present embodiment is intended to provide a camera device that can reduce manufacturing costs and adjust the angle of view to a beam angle within a desired range.

In addition, it is intended to provide a camera device that can easily adjust the angle of view to a beam angle within a desired range even after mounting.

### Technical Solution

A camera device according to the present embodiment comprises: a moving portion including a lens; a fixed portion being coupled to the moving portion; a plate being disposed between the moving portion and the fixed portion; and an adjuster for adjusting the movement of the moving portion, wherein the adjuster includes an elastic member, an adjusting member, and a body, and wherein the body includes: a base; a first side wall being extended from the base and being in contact with the fixed portion; and a second side wall being extended from the base and being in contact with the moving portion.

The elastic member is formed integrally with the plate and may include a first region being extended to one side of the plate and a second region being bent from the first region.

When the gap between the base of the body and the fixed portion becomes smaller, the gap between the first region and the second region of the elastic member may become smaller.

The gap between the plate and the fixed portion may be adjusted by a gap between the first region and the second region of the elastic member.

The elastic member is disposed between the fixed portion and the moving portion, and one side of the elastic member may be in contact with the fixed portion.

The base may include a hole into which the adjusting member is inserted.

The angle formed by the base and the first side wall may be different from the angle formed by the base and the second side wall.

The angle formed by the base and an inner surface of the first side wall is a right angle, and the angle formed by the base and an inner surface of the second side wall may be an obtuse angle.

When the gap between the base of the body and the fixed portion becomes smaller, an optical axis of the lens may be tilted to one direction from a reference point.

A camera device according to another embodiment comprises: a moving portion including a lens; a fixed portion being coupled with the moving portion; a plate being disposed between the moving portion and the fixed portion; and an adjuster for adjusting the movement of the moving portion, wherein the adjuster includes an elastic member and a body, and wherein an optical axis of the lens is tilted in one direction or the other direction from a reference point when the body moves in a direction perpendicular to the optical axis of the lens.

### Advantageous Effects

Through the present embodiment, it is possible to provide a camera device that can adjust the angle of view to a beam angle within a desired range.

In addition, it is possible to provide a camera device that can minimize changes in angle of view due to manufacturing tolerances of the camera module or tolerances that occur during mounting on a vehicle.

In addition, it is possible to provide a camera device that can minimize changes in angle of view caused by external forces or vibration during the installation process or after installation on a vehicle.

In addition, it is possible to provide a camera device that can readjust the angle of view being changed due to external forces after mounted on a vehicle.

### BRIEF DESCRIPTION OF DRAWINGS

FIG. 1 is a schematic diagram of a vehicle installed with a camera device according to an embodiment of the present invention.

FIG. 2 is a perspective view illustrating the appearance of a camera device according to an embodiment of the present invention.

FIG. 3 is a perspective view illustrating FIG. 2 from another angle.

FIG. 4 is a perspective view illustrating a rear surface of a camera device according to an embodiment of the present invention.

FIG. 5 is a perspective view illustrating a rear surface of a camera device excluding a fixed portion according to an embodiment of the present invention.

FIG. 6 is an exploded perspective view of a camera device according to an embodiment of the present invention.

FIG. 7 is an exploded perspective view of a camera device illustrating FIG. 6 from a different angle.

FIG. 8 is a cross-sectional view of a camera device according to an embodiment of the present invention.

FIG. 9 is a cross-sectional view of a camera device excluding the fixed portion in FIG. 8.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or arranged in “on (above)” or “below (under)” of each component, “on (above)” or “below (under)” means that it includes not only the case where the two components are directly in contact with, but also the case where one or more other components are formed or arranged between the two components. In addition, when expressed as “on (above)” or “below (under)”, the meaning of not only an upward direction but also a downward direction based on one component may be included.

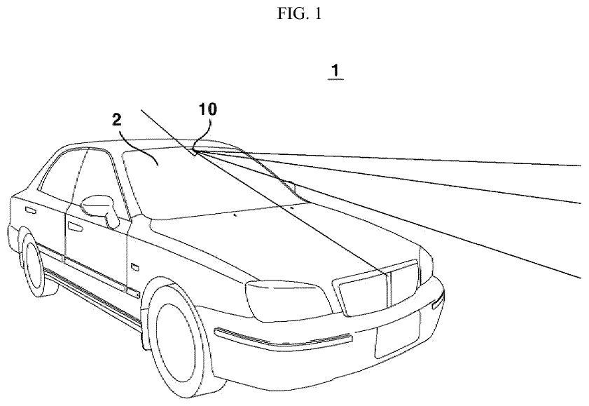

FIG. 1 is a schematic diagram of a vehicle installed with a camera device according to an embodiment of the present invention.

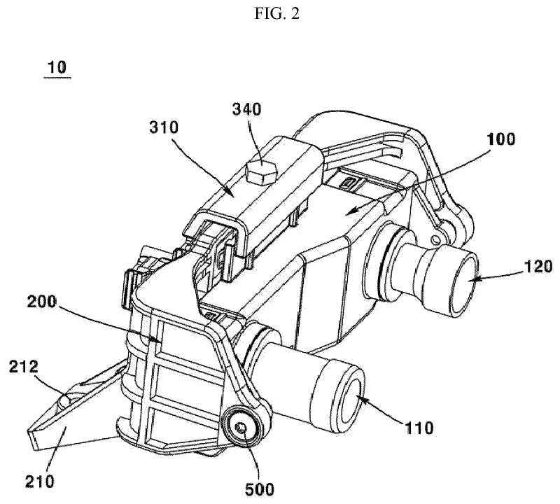

Referring to FIG. 1, the camera device 10 according to an embodiment of the present invention may be coupled to the wind glass 2 of a vehicle 1. The wind glass 2 can be disposed in the front or rear of the vehicle 1. The wind glass 2 is made of a transparent material and allows the driver to look ahead or behind. The wind glass 2 may include a front wind glass disposed in the front of the vehicle 1 and a rear wind glass being disposed at the rear of the vehicle. The camera device 10 may be coupled to an inner surface of the wind glass 2. In an embodiment of the present invention, the camera device 10 is described as being coupled to the front wind glass as an example, but may also be coupled to the rear wind glass. The bracket 200 (see FIG. 2) of the camera device 10 may be directly coupled to an inner side surface of the wind glass 2 by adhesive or other methods, but it is not excluded that the camera device 10 is coupled to the wind glass 2 through a separate coupler (not shown) and/or cover (not shown).

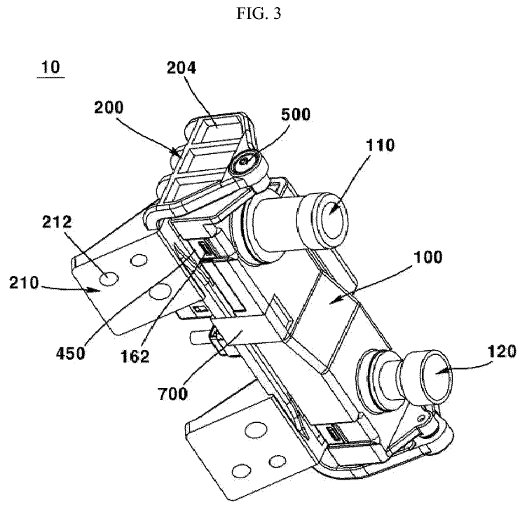

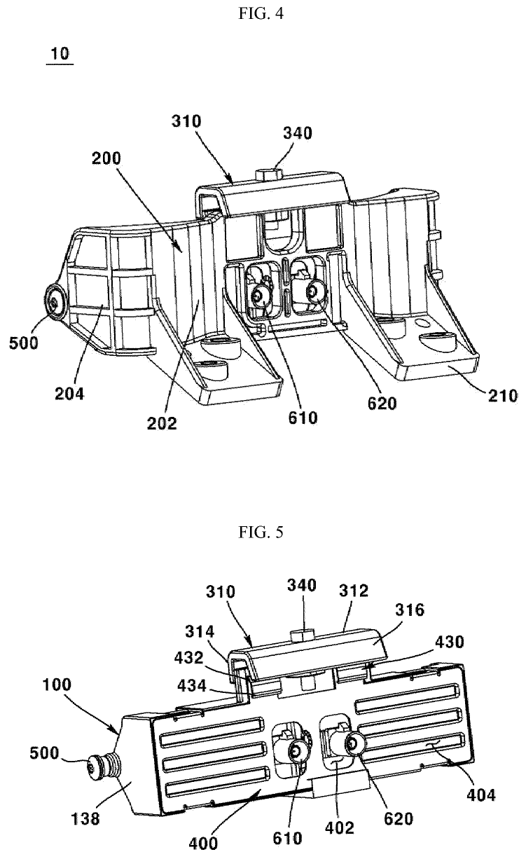

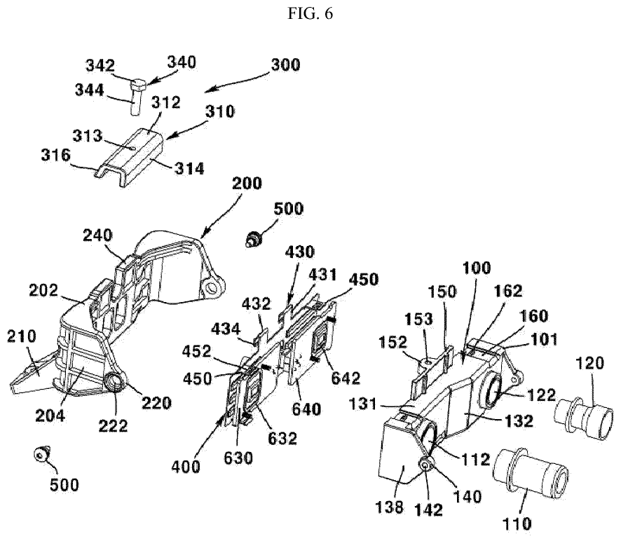

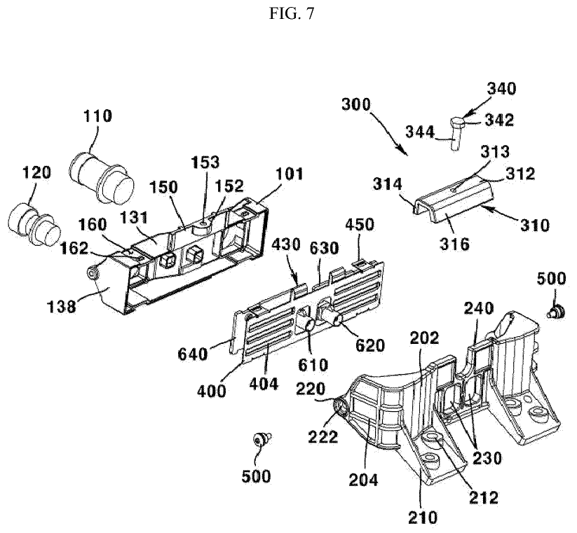

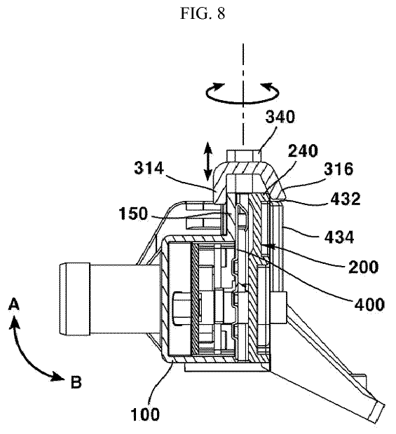

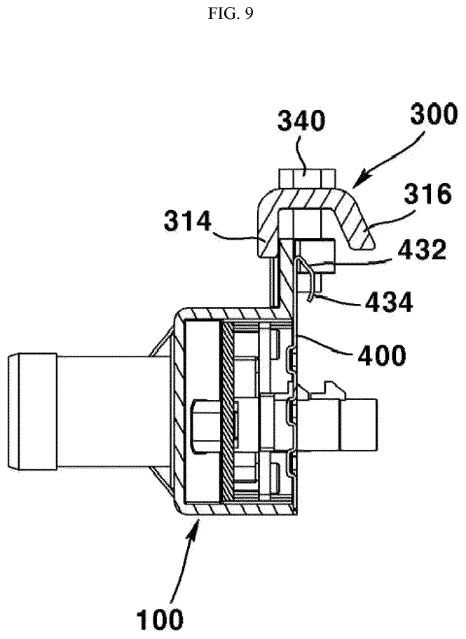

FIG. 2 is a perspective view illustrating the appearance of a camera device according to an embodiment of the present invention; FIG. 3 is a perspective view illustrating FIG. 2 from another angle; FIG. 4 is a perspective view illustrating a rear surface of a camera device according to an embodiment of the present invention; FIG. 5 is a perspective view illustrating a rear surface of a camera device excluding a fixed portion according to an embodiment of the present invention; FIG. 6 is an exploded perspective view of a camera device according to an embodiment of the present invention; FIG. 7 is an exploded perspective view of a camera device illustrating FIG. 6 from a different angle; FIG. 8 is a cross-sectional view of a camera device according to an embodiment of the present invention; and FIG. 9 is a cross-sectional view of a camera device excluding the fixed portion in FIG. 8.

Referring to FIGS. 2 to 9, a camera device 10 according to an embodiment of the present invention may include a moving portion 100, a fixed portion 200, an adjuster 300, and a plate 400, but it may be implemented excluding some of these components, and additional components are not excluded.

The camera device 10 may be installed on the wind glass 2 of the vehicle 1. The camera device 10 can adjust the photographing direction of the moving portion 100. Through this, the angle of view can be adjusted within the range of the beam angle desired by a user by compensating for manufacturing tolerances of the moving portion 100 or mounting tolerances on the vehicle 1.

The camera device 10 may include the moving portion 100. The moving portion 100 may also be called a housing 100 in that it forms the outer shape of the camera device 10. The moving portion 100 may include at least one or more lenses 110 or 120. In the present embodiment, the camera device 10 is described as an example of a dual camera, but it is not limited to this and can be modified in various ways, such as a triple camera.

The lenses 110 and 120 include a first lens 110 and a second lens 120, and may be disposed on a front surface of the moving portion 100. Mounting portions 112 and 122 to which the first lens 110 and the second lens 120 are coupled may be disposed on a front surface of a housing 101 that forms the external shape of the moving portion 100. The mounting portions 112 and 122 have an opening shape and may include a first mounting portion 112 to which the first lens 110 is coupled and a second mounting portion 122 to which the second lens 120 is coupled. The front surface of the housing 101 has a plurality of regions being disposed to be stepped from each other, and the first mounting portion 112 and the second mounting portion 122 may be disposed in each of the plurality of regions.

Meanwhile, in the present embodiment, the lenses 110 and 120 are examples of the lenses themselves, but this is not limited. The lenses 110 and 120 may be lens barrels, and at least one or more lenses may be disposed inside the lens barrel.

The housing 101 may include: a front surface portion 132 on which the mounting portions 112 and 122 are formed; an upper surface portion 131 forming an upper surface; and a side surface portion 138 being disposed on both sides of the front surface portion 132 and forming a side surface. The front end of the side surface portion 138 may be formed to be protruded forward from the front surface portion 132, and a first coupling portion 140 for coupling to the fixed portion 200 may be disposed at a front end of the side surface portion 138. The first coupling portion 140 includes a first coupling hole 142 and can be hinge-coupled to the fixed portion 200. The moving portion 100 may be rotated about the first coupling hole 142 as a rotation center. Accordingly, the angle of view of the camera device 10 can be adjusted.

A space in which at least one electronic component is disposed may be formed at a rear surface of the housing 101. For example, on a rear surface of the housing 101, a first printed circuit board 630 having a first image sensor 632 being disposed to face the first lens 110 in an optical axis direction, and a second printed circuit board 640 being disposed to face the lens 120 in an optical axis direction may be disposed. Here, it is exemplified that the first image sensor 632 and the second image sensor 642 are respectively disposed on each of the first printed circuit board 630 and the second printed circuit board 640, but of course, it can be disposed on a circuit board.

A first guide 150 being protruded more upward than other regions may be disposed on an upper surface of the housing 101. The first guide 150 may be disposed at the center of the upper surface portion 131. The first guide 150 has a plate shape and can be coupled with the body 310, which will be described later. At a rear surface of the first guide 150, a second guide 152 is disposed being protruded more rearward than other regions, and a hole 153 into which an adjusting member 340, which will be described later, is coupled may be formed on an upper surface of the second guide 152.

A first coupling groove 160 for coupling with the plate 400 may be respectively disposed on an upper surface and a lower surface of the housing 101. Two each of the first coupling grooves 160 may be disposed on the upper surface portion 131 of the housing 101, and two each thereof may be disposed on a lower surface of the housing 101. For example, the two of the first coupling grooves 160 being disposed in the upper surface portion 131 may be disposed to be spaced apart from each other on both sides of the first guide 150.

The first coupling groove 160 has a shape being recessed more downward than other regions of an upper surface of the housing 101, and a third coupling portion 450 of the plate 400, which will be described later, may be coupled thereto. On a bottom surface of the first coupling groove 160, a protrusion 162 being protruded from the bottom surface may be formed. A portion of an outer surface of the protrusion 162 may be an inclined surface.

The camera device 10 may include the fixed portion 200. The fixed portion 200 may also be called a bracket 200 in that it fixes the camera device 10 to an installation region.

The fixed portion 200 may be coupled with the moving portion 100. The fixed portion 200 may be coupled to a rear surface of the moving portion 100. The moving portion 100 may be tiltably coupled against the fixed portion 200.

The fixed portion 200 may include: a rear surface portion 202 being coupled to a rear surface of the moving portion 100; and a plurality of side surface portions 204 being bent and extended forward from both ends of the rear surface portion 202 and forming a side surface. A second coupling portion 220 may be disposed at an end portion of the side surface portion 204 being extending forward. The second coupling portion 220 may be disposed to face the first coupling portion 140. The second coupling portion 220 may include a second coupling hole 222. The second coupling hole 222 may be disposed to face the first coupling hole 142.

The camera device 10 is coupled to the first coupling hole 142 and the second coupling hole 222, and may include a coupling shaft 500 that forms the center of rotation of the moving portion 100. The coupling shaft 500 may be fitted on an outside of the second coupling portion 220 so that at least a portion thereof penetrates the second coupling hole 222 and the first coupling hole 142. The moving portion 100 may rotate (tilt) clockwise or counterclockwise about the coupling shaft 500 through an adjuster 300, which will be described later. The coupling shaft 500 may include a screw.

A fixing plate 210 being extended rearward may be disposed on a rear surface of the fixed portion 200. The fixing plate 210 may have a shape being extended outward from the rear end of rear surface of the fixed portion 200. The fixing plate 210 may include at least one or more of screw holes 212. Accordingly, a screw is screw-coupled into the screw hole 212, and the camera device 10 can be fixed to an installation region.

A connector hole 230 penetrating from a front surface to a rear surface may be disposed on the rear surface portion 202 of the fixed portion 200. The connector hole 270 is for connectors 610 and 620 to penetrate therethrough, one end of the connectors 610 and 620 is coupled to the printed circuit boards 630 and 640, and the other end penetrates the connector hole 230, so that it may be disposed to be protruded more rearward than the rear surface of the fixed portion 200. The connector hole 230 may be provided in plural numbers corresponding to the number of connectors 610 and 620.

The connector hole 230 may be a long hole whose lengthwise direction is formed in an up and down direction. Accordingly, the connector may move within the connector hole 230 when the moving portion 100 moves.

A third guide 240 being protruded more upward than other regions may be disposed on an upper surface of the fixed portion 200. The third guide 240 may be disposed to face the first guide 150 in an optical axis direction. A groove may be formed in the center of the third guide 240 to accommodate at least a portion of the second guide 152.

The camera device 10 may include a plate 400. The plate 400 may be disposed between the moving portion 100 and the fixed portion 200. The plate 400 may be coupled to a rear surface of the moving portion 100. The plate 400 may be made of metal. The plate 400 may be coupled to cover the rear surface of the space inside the moving portion 100. Accordingly, the printed circuit boards 630 and 640 may be disposed between the plate 400 and a space inside the moving portion 100.

The plate 400 may include a penetrating hole 402 through which the connectors 610 and 620 penetrates. The penetrating hole 402 may be formed to penetrate from a front surface to a rear surface of the plate 400.

A concave portion 404 may be formed on a rear surface of the plate 400 in a shape that is recessed more forward than other regions. The concave portion 404 may have a groove shape. The concave portion 404 may be provided in plurality and disposed to be spaced apart from each other. The concave portion 404 may be a long groove having a predetermined length. The lengthwise direction of the concave portion 404 may be defined as a left and right direction connecting both sides of the plate 400. The rigidity of the plate 400 can be reinforced through the concave portion 404.

A protruded portion being protruded forward may be disposed on a front surface of the plate 400 corresponding to a region where the concave portion 404 is formed.

The plate 400 may include a third coupling portion 450. The third coupling portion 450 may have a shape in which a portion of an edge of the plate 400 is bent forward and extended. The third coupling portion 450 may be coupled to the moving portion 100. The third coupling portion 450 may be coupled to the first coupling groove 160. The third coupling portion 450 may be provided in plural numbers corresponding to the number of first coupling grooves 160. For example, two each of the third coupling portions 450 are disposed at an upper end of the plate 400 to be spaced apart from each other, and two each of the third coupling portions 450 may be disposed at a lower end to be spaced apart from each other.

The third coupling portion 450 includes a third coupling hole 452, and the third coupling hole 452 may be coupled to the protrusion 162. In other words, the plate 400 and the moving portion 100 may be hook-coupled through the third coupling hole 452 and the protrusion 162.

The camera device 10 may include an adjuster 300. The adjuster 300 is used for adjusting the angle of view of the camera device 10 and can move the moving portion 100.

The adjuster 300 may include an elastic member 430, an adjusting member 340, and a body 310.

The elastic member 430 may be a component of the plate 400. The elastic member 430 may be formed as one body with the plate 400. The elastic member 430 may include a first region 431 being extended upward from an upper end of the plate 400, and second regions 432 and 434 being bent downward from an upper end of the first region 431. In the present embodiment, the elastic member 430 is shown to be formed integrally with the plate 400, but it may be a separate component.

The elastic member 430 may be elastically deformed in a direction perpendicular to the direction of movement of the body 310. The first region 431 and the second regions 432 and 434 may become closer to or move away from each other as the body 310 moves. More specifically, when the gap between the base 312 of a body 310, which will be described later, and the fixed portion 200 becomes smaller, the gap between the first region 431 and the second regions 432 and 434 becomes smaller. In addition, when the gap between the base 312 of the body 310 and the fixed portion 200 becomes distant, the gap between the first region 431 and the second regions 432 and 434 may become distant.

In addition, the gap between the plate 400 and the fixed portion 200 can be adjusted by the gap between the first region 431 and the second regions 432 and 434 of the elastic member 430.

The elastic member 430 may be disposed between a rear surface of the first guide 150 and the rear surface portion 202 of the fixed portion 200, that is, a front surface of the third guide 240. The second regions 432 and 434 may have a region bent at least once or more. The second regions 432 and 434 may include a second-first region 432 and a second-second region 434, which are partitioned in an up and down direction with respect to the bent region. The bent region may have a shape being protruded more rearward than other regions.

The body 310 may be coupled to an upper portion of the moving portion 100 and the fixed portion 200. At least a portion of the body 310 may be in contact with the front surface of the first guide 150, and another portion may be in contact with the rear surface of the fixed portion 200.

The body 310 may include: a base 312; a first sidewall 316 being extending from the base 312 and in contact with the fixed portion 200; a second sidewall 314 being extended from the base 312 and in contact with the moving portion 100. The first sidewall 316 is extended from the rear of the base 312, and the second sidewall 314 may be extended from the front of the base 312. The first sidewall 316 and the second sidewall 314 may have a shape being protruded downward from the front and rear surfaces of the base 312.

The angle formed by the base 312 and the first side wall 316 may be different from the angle formed by the base 312 and the second side wall 314. For example, the first side wall 316 may be formed to be inclined so that the distance to a rear surface of the fixed portion 200 increases as it moves downward. At this time, the angle formed by the first side wall 316 and the base 312 may be an obtuse angle. The second sidewall 314 may be disposed perpendicular to the base 312.

The moving direction of the body 310 may not be parallel to an optical axis of the lenses 110 and 120.

A hole 313 through which the adjusting member 340 penetrates from an upper surface to a lower surface to be coupled thereto may be formed in the base 312. A screw thread or screw groove may be formed on an inner circumferential surface of the hole 313, and the adjusting member 340 can be screw-coupled accordingly.

The base 312 may be disposed to be overlapped with the second guide 152 in an up and down direction. The hole 313 in the base 312 may be disposed to face the hole 153 of the second guide 152 in up and down direction.

The adjusting member 340 may penetrate through the hole 313 of the base 312 and screw-coupled to the hole 153 of the second guide 152. The adjusting member 340 may also be called a screw 340. The adjusting member 340 may include a head portion 342 and a fastening portion 344 being protruded downward from a lower surface of the head portion 342 and coupled to the holes 313 and 153. The camera device 10 may include a control unit (not shown) that controls the rotation of the adjusting member 340. As the adjusting member 340 rotates, the moving portion 100 may be tilted against the fixed portion 200.

The control unit is for controlling the rotation of the adjusting member 340, and can move the body 310 in an up and down direction through the rotation of the adjusting member 340. The adjusting member 340 may be connected to a separate driving unit such as a step motor, and the control unit may control the rotation of the adjusting member 340 through control of the step motor.

Of course, the adjusting member 340 can be manually rotated by a user.

According to the above structure, when the gap between the base 312 of the body 310 and the fixed portion 200 becomes smaller, the optical axes of the lenses 110 and 120 may be tilted in one direction from the reference point. In addition, the optical axes of the lenses 110 and 120 may be tilted from the reference point to the other direction when the gap between the base 312 of the body 310 and the fixed portion 200 increases.

Here, the reference point may be a region where the optical axes of the lenses 110 and 120 are initially set during the assembly process of the camera device 10.

Accordingly, the optical axis of the lens 110 or 120 may be tilted in one direction or the other direction from the reference point when the body 310 moves in a direction perpendicular to the optical axis of the lens 110 or 120. With respect to the reference point, the lenses 110 and 120 may have a rotation angle of 20 degrees in one direction or the other direction. This takes into account the gap between the fixed portion 200 and the plate 400, and this is in consideration of the deformation of the components inside the camera device 10 when the moving portion rotates beyond the set range and that the space inside the camera device 10 is excessively open.

With reference to FIG. 8, the body 310 moves downward when the control member 340 is rotated in one direction by the control unit, and the moving portion 100 including the lenses 110 and 120 may be moved in a first direction A by the contact between the first side wall 316 and the fixed portion 200 and the contact between the second side wall 314 and the moving portion 100. This can be understood as the optical axes of the lenses 110 and 120 are tilted upward when the body 310 moves downward. In addition, when the body 310 moves downward, the gap between the upper side of the plate 400 and the upper side of the fixed portion 200 may become narrow, and the gap between the lower side of the plate 400 and the lower side of the fixed portion 200 may become widened.

In addition, when the adjusting member 340 is rotated in the other direction by the control unit, the body 310 moves upward, and the moving portion 100 including the lenses 110 and 120 may be moved in a second direction B due to a change in the contact region between the fixed portion 200 and the first sidewall 316. This can be understood as when the body 310 moves upward, the optical axes of the lenses 110 and 120 are tilted downward. And, when the body 310 moves upward, the gap between the upper side of the plate 400 and the upper side of the fixed portion 200 may be widened, and the gap between the lower side of the plate 400 and the lower side of the fixed portion 200 may be narrowed.

Meanwhile, the camera device 10 may include a clip 700 that restricts the movement of the moving portion 100, and the clip 700 may be coupled to a lower surface of the camera device 10. As an example, a portion of the clip 700 may be coupled to a lower surface of the moving portion 100, and the other portion may be coupled to a lower surface of the fixed portion 200. The clip 700 can prevent the moving portion 100 from being excessively tilted in a first direction A.

According to the above structure, it is possible to provide a camera device that can adjust the angle of view to a beam angle within a desired range.

In addition, it is possible to provide a camera device that can minimize changes in angle of view due to manufacturing tolerances of the camera module or tolerances that occur when mounted on a vehicle.

In addition, it is possible to provide a camera device that can minimize changes in angle of view caused by external forces or vibration during mounting process or after mounting on a vehicle.

In the above description, it is described that all the components constituting the embodiments of the present invention are combined or operated in one, but the present invention is not necessarily limited to these embodiments. In other words, within the scope of the present invention, all of the components may be selectively operated in combination with one or more. In addition, the terms “comprise”, “include” or “having” described above mean that the corresponding component may be inherent unless specifically stated otherwise, and thus it should be construed that it does not exclude other components, but further include other components instead. All terms, including technical and scientific terms, have the same meaning as commonly understood by one of ordinary skill in the art unless otherwise defined. Terms used generally, such as terms defined in a dictionary, should be interpreted to coincide with the contextual meaning of the related art, and shall not be interpreted in an ideal or excessively formal sense unless explicitly defined in the present invention.

The above description is merely illustrative of the technical idea of the present invention, and those skilled in the art to which the present invention pertains may make various modifications and changes without departing from the essential characteristics of the present invention. Therefore, the embodiments disclosed in the present invention are not intended to limit the technical idea of the present invention but to describe the present invention, and the scope of the technical idea of the present invention is not limited by these embodiments. The protection scope of the present invention should be interpreted by the following claims, and all technical ideas within the equivalent scope should be interpreted as being included in the scope of the present invention.

1. A camera device comprising:
a moving portion including a lens;
a fixed portion coupled to the moving portion;
a plate disposed between the moving portion and the fixed portion; and
an adjuster configured to adjust movement of the moving portion,
wherein the adjuster includes an adjusting member and a body, and
wherein the body includes a base, a first sidewall extended from the base and in contact with the fixed portion, and a second side wall extended from the base and in contact with the moving portion.

2. The camera device according to claim 1,
wherein the elastic member is formed integrally with the plate and includes a first region extended to one side of the plate and a second region bent from the first region.

3. The camera device according to claim 2,
wherein when a gap between the base of the body and the fixed portion becomes smaller, a gap between the first region and the second region of the elastic member becomes smaller.

4. The camera device according to claim 2,
wherein a gap between the plate and the fixed portion is adjusted by a gap between the first region and the second region of the elastic member.

5. The camera device according to claim 1,
wherein the elastic member is disposed between the fixed portion and the moving portion, and one side of the elastic member is in contact with the fixed portion.

6. The camera device according to claim 1,
wherein the base includes a hole into which the adjusting member is inserted.

7. The camera device according to claim 1,
wherein an angle formed by the base and the first side wall is different from an angle formed by the base and the second side wall.

8. The camera device according to claim 7,
wherein an angle formed by the base and an inner surface of the first side wall is a right angle, and an angle formed by the base and an inner surface of the second side wall is an obtuse angle.

9. The camera device according to claim 1,
wherein when a gap between the base of the body and the fixed portion becomes smaller, an optical axis of the lens is tilted to one direction from a reference point.

10. The camera device:
according to claim 9, wherein when the gap between the base of the body and the fixed portion increases, the optical axis of the lens is tilted from the reference point to an other direction.

11. The camera device according to claim 1, wherein when the body moves downward, an optical axis of the lens is tilted upward, and
wherein when the body moves upward, the optical axis of the lens is tilted downward.

12. The camera device according to claim 1, wherein when the body moves downward, a gap between an upper side of the plate and an upper side of the fixed portion narrows, and a gap between a lower side of the plate and a lower side of the fixed portion widens.

13. The camera device according to claim 1, comprising: a control unit that controls the adjuster.

14. The camera device according to claim 2, wherein the elastic member is deformed in a direction perpendicular to a direction of movement of the body.

15. The camera device according to claim 1, comprising a clip, wherein the clip limits the movement of the moving portion, and
wherein the clip is coupled to the moving portion and the fixed portion.

16. A camera device comprising:
a moving portion including a lens;
a fixed portion coupled with the moving portion;
a plate disposed between the moving portion and the fixed portion; and
an adjuster configured to adjust movement of the moving portion,
wherein the adjuster includes an elastic member and a body, and
wherein an optical axis of the lens is tilted in one direction or an other direction from a reference point when the body moves in a direction perpendicular to the optical axis of the lens.

17. The camera device according to claim 16, wherein when the body moves downward, the optical axis of the lens is tilted upward, and
wherein when the body moves upward, the optical axis of the lens is tilted downward.

18. The camera device according to claim 16, wherein when the body moves downward, a gap between an upper side of the plate and an upper side of the fixed portion narrows, and a gap between a lower side of the plate and a lower side of the fixed portion widens.

19. The camera device according to claim 16, wherein the elastic member is deformed in a direction perpendicular to a direction of movement of the body.

20. The camera device according to claim 16, comprising a clip, wherein the clip limits the movement of the moving portion, and
wherein the clip is coupled to the moving portion and the fixed portion.
